(19) United States
(12) Patent Application Publication
(10) Pub. No.: US 2019/0026881 A1
(43) Pub. Date: Jan. 24, 2019

(54) METHOD OF VISUALIZING DEFECT USING DESIGN DATA AND DEFECT DETECTION METHOD

(71) Applicant: NGR Inc., Yokohama (JP)

(72) Inventor: Yoshishige SATO, Yokohama (JP)

(21) Appl. No.: 16/009,660

(22) Filed: Jun. 15, 2018

(30) Foreign Application Priority Data
Jun. 19, 2017 (JP) 2017-119829

(51) Int. Cl. G06T 7/00; G06T 7/12; G06T 7/90

(52) U.S. Cl. CPC G06T 7/001; G06T 7/12; G06T 2207/10061; G06T 2207/30148; G06T 7/90

(57) ABSTRACT

A method of visualizing a defect of a pattern constituting a semiconductor device with a high accuracy in a wide range is disclosed. The method of visualizing a defect, includes: generating pattern images with a scanning electron microscope; superimposing the pattern images while aligning positions of patterns in the pattern images; calculating a variance of gray level over the pattern images for each of inspection areas on the patterns; creating a false-color image by color-coding the inspection areas according to magnitude of the variance; and displaying the false-color image.

### CROSS REFERENCE TO RELATED APPLICATION

This document claims priority to Japanese Patent Application No. 2017-119829 filed Jun. 19, 2017, the entire contents of which are hereby incorporated by reference.

### BACKGROUND

An optical pattern inspection apparatus, which uses a die-to-die comparison method, is used for a wafer pattern inspection in a semiconductor integrated circuit manufacturing process or for a pattern inspection of photomask that forms wafer patterns. The die-to-die comparison method is a technique of detecting a minute defect by comparing an image of a semiconductor device, which is referred to as a die to be inspected, with an image obtained at the same position in an adjacent die.

On the other hand, for the inspection of a photomask (reticle) having no adjacent die, a die-to-database comparison method has been used. In this die-to-database comparison method, mask data are converted into an image. The image is then used for a substitution of the image of the adjacent die used in the die-to-die comparison method, and inspection is performed in the same manner as discussed above. The mask data are data obtained by applying photomask correction to design data. This technology concerned is disclosed, for example, in U.S. Pat. No. 5,563,702, “Automated photomask inspection apparatus and method.”

However, when the die-to-database comparison method is used for wafer inspection, corner roundness of a pattern actually formed on a wafer is likely to be detected as a defect. In the inspection of a photomask, a pre-processing, which adds corner roundness to the image converted from the mask data by applying a smoothing filter, is carried out for preventing the corner roundness of the pattern from being detected as the defect. However, in the wafer inspection, because the corner roundness added by the pre-processing may be different from corner roundness of each pattern actually formed on the wafer, the pre-processing may not perfectly prevent the corner roundness of the pattern from being detected as the defect. Therefore, an allowable pattern deformation quantity should be set in order to ignore the above difference. As a result, a problem in which a defect existing in a place except a corner cannot be detected has happened.

From a viewpoint of problems in semiconductor integrated circuit fabrication, repeated defects (systematic defects) are more important issue than a random defect caused by a particle or the like. The repeated defects are defined as defects that occur repeatedly over all dies on a wafer caused by photomask failure or the like. Since the repeated defects occur in a die to-be-inspected and in adjacent dies that are to be compared with the die to-be-inspected, the die-to-die comparison wafer inspection cannot detect the repeated defects. Accordingly, a wafer inspection based on the die-to-database comparison has been demanded.

However, in both the die-to-database comparison method for the systematic defects and the die-to-die method for the random defects, it is known that a defect detection rate decreases as the size of the defect approaches LER (or line edge roughness). Specifically, since measurement results of a two-dimensional pattern include LER (line edge roughness) which is a pattern deformation that is not a defect caused by a variation in chemical reaction at a pattern boundary surface, it is a common practice that an allowable pattern deformation level with respect to the design data in the die-to-database comparison method is larger than the LER (line edge roughness). As a result, it becomes difficult to detect a defect, as the size of the defect comes closer to the size of the LER (line edge roughness).

### SUMMARY OF THE INVENTION

Therefore, according to embodiments, there is provided a method of visualizing a defect of a pattern constituting a semiconductor device with a high accuracy in a wide range, and there is provided a method of detecting a defect in a wide range with a high accuracy.

Embodiments, which will be described below, relate to an image generation method applicable to a defect detection method for a pattern, constituting a semiconductor integrated circuit (LSI) or a liquid crystal panel, manufactured based on design data.

In an embodiment, there is provided a method of visualizing a defect, comprising: generating pattern images with a scanning electron microscope; superimposing the pattern images while aligning positions of patterns in the pattern images; calculating a variance of gray level over the pattern images for each of inspection areas on the patterns; creating a false-color image by color-coding the inspection areas according to magnitude of the variance; and displaying the false-color image.

In an embodiment, the inspection areas are established in advance based on shape of the patterns contained in a design data.

In an embodiment, at least one of the inspection areas is an area on an edge of the patterns.

In an embodiment, there is provided a defect detection method comprising: generating pattern images with a scanning electron microscope; superimposing the pattern images while aligning positions of patterns in the pattern images; producing data of gray levels for each of inspection areas on the patterns by obtaining gray levels over the pattern images for each of the inspection areas; determining threshold values corresponding respectively to the inspection areas, based on the data of gray levels; comparing a gray level of each one of pixels in the inspection areas with a corresponding threshold value of the threshold values; applying a first color to pixels having gray levels higher than the threshold value, and applying a second color to pixels having gray levels lower than the threshold value, thereby generating a binary image; and detecting a pattern defect by detecting connected pixels of the first color whose number is equal to or greater than a set number.

In an embodiment, each of the threshold values is determined based on a quartile range or a standard deviation of the data.

According to the above embodiments, a pattern image expressed in gray scale is converted into a false-color image that has been color-coded in accordance with the magnitude of the variance of the gray level. Therefore, a user can easily visually recognize an area where a defect exists.

### BRIEF DESCRIPTION OF THE DRAWINGS

FIG. 1 is a schematic diagram showing an embodiment of an image generation system including a scanning electron microscope;

FIG. 2 is a schematic diagram showing a layout of shots on a wafer;

FIG. 3 is a schematic diagram showing a layout of patterns in a shot;

FIG. 4 is a schematic diagram showing a part of a pattern that does not include a defect;

FIG. 5 is a schematic diagram showing a part of a pattern that includes a defect;

FIG. 6 is a diagram showing a plurality of inspection areas defined on a pattern;

FIG. 7 is a diagram showing pattern images superimposed on one another;

FIG. 8 is a flowchart illustrating displaying of a false-color image;

FIG. 9 is a flowchart illustrating an embodiment for detecting a pattern defect;

FIG. 10 is a flowchart illustrating the embodiment for detecting a pattern defect;

FIG. 11 is a diagram showing an example of a binary image; and

FIG. 12 is a schematic diagram showing a structure of a computer.

### DESCRIPTION OF EMBODIMENTS

Embodiments will be described below with reference to the drawings.

An object of an embodiment described below is to visualize a minute defect of the same size as LER (line edge roughness). The visualization is performed as post-processing of die-to-database comparison method and die-to-die comparison method.

Another object of an embodiment is to detect a minute defect having a size equivalent to LER (line edge roughness). The detection is performed as post-processing of a die-to-database comparison method and a die-to-die comparison method.

Still another object of an embodiment is to provide a method of defining areas for minute-defect visualization and minute-defect detection using design data, so that threshold values for use in a binary image generation belong to the areas that have been defined based on the design data, thereby reducing a calculation amount of the threshold values. The design data is classified into lines, spaces, corners, and pattern ends. In addition, it is possible to calculate independent threshold values for an end portion and a central portion of a pattern, and for patterns with different sizes. Pattern center determination, and subdivision of the areas in accordance with pattern size can be freely set. In other words, it is not necessary to provide one million threshold values for an image of 1,000 pixels in the vertical direction and 1,000 pixels in the horizontal direction. In the embodiment, the threshold values belong to a pattern.

Still another object of an embodiment is to improve the accuracy of establishing a threshold value by using a quartile range or a standard deviation value in calculation of the threshold value for minute-defect detection to statistically select information used for calculating the threshold value.

Still another object of an embodiment is to improve the effect of visual recognition of a minute defect by converting a grayscale image, which is typically used in SEM images, into a false-color image, in consideration of the property of human eyes having a high perceptivity to RGB tones.

Hereinafter, embodiments will be described in detail with reference to the drawings.

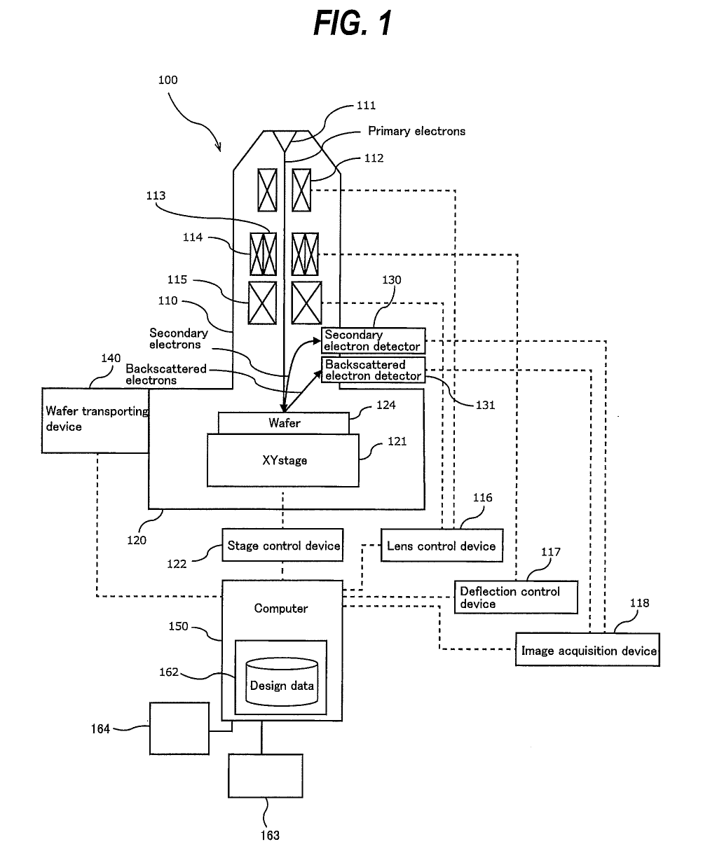

FIG. 1 is a schematic diagram showing an embodiment of an image generation system including a scanning electron microscope.

As shown in FIG. 1, the image generation system includes a scanning electron microscope 100 and a computer 150 for controlling operations of the scanning electron microscope. The scanning electron microscope 100 includes an electron gun 111 that emits an electron beam composed of primary electrons (charged particles), a converging lens 112 that converges the electron beam emitted from the electron gun 111, an X deflector 113 that deflects the electron beam in an X direction, a Y deflector 114 for deflecting the electron beam in a Y direction, and an objective lens 115 for focusing the electron beam on a wafer 124 which is a specimen.

The converging lens 112 and the objective lens 115 are coupled to a lens control device 116, and operations of the converging lens 112 and the objective lens 115 are controlled by the lens control device 116. This lens control device 116 is coupled to the computer 150. The X deflector 114 and the Y deflector 115 are coupled to a deflection control device 117, and deflection operations of the X deflector 113 and the Y deflector 114 are controlled by the deflection control device 117. This deflection control device 117 is also coupled to the computer 150. A secondary electron detector 130 and a backscattered electron detector 131 are coupled to an image acquisition device 118. This image acquisition device 118 is configured to convert output signals of the secondary electron detector 130 and the backscattered electron detector 131 into an image. This image acquisition device 118 is also coupled to the computer 150.

An XY stage 121 is disposed in a specimen chamber 120. This XY stage 121 is coupled to a stage control device 122, so that the position of the XY stage 121 is controlled by the stage control device 122. This stage control device 122 is coupled to the computer 150. A wafer transporting device 140 for placing the wafer 124 onto the XY stage 121 in the specimen chamber 120 is also coupled to the computer 150. The computer 150 includes a memory 162 in which a design database is stored, an input device 163 such as a keyboard and a mouse, and a display device 164.

The electron beam emitted from the electron gun 111 is converged by the converging lens 112, and is then focused by the objective lens 115 onto the surface of the wafer 124, while the electron beam is deflected by the X deflector 113 and the Y deflector 114. When the wafer 124 is irradiated with the primary electrons of the electron beam, secondary electrons and backscattered electrons are emitted from the wafer 124. The secondary electrons are detected by the secondary electron detector 130, and the backscattered electrons are detected by the backscattered electron detector 131. The signals of the detected secondary electrons and the signals of the backscattered electrons are input into the image acquisition device 118, and are converted into image data. The image data is transmitted to the computer 150, and an image of the wafer 124 is displayed on the display device 164 of the computer 150.

A design data (including pattern design information) of the wafer 124 is stored in advance in the memory 162. The design data is a design diagram of plural types of patterns, such as interconnect, gate, and transistor. The design data of the wafer 124 is stored in advance in the memory 162. The computer 150 can retrieve the design data of the wafer 124 from the memory 162.

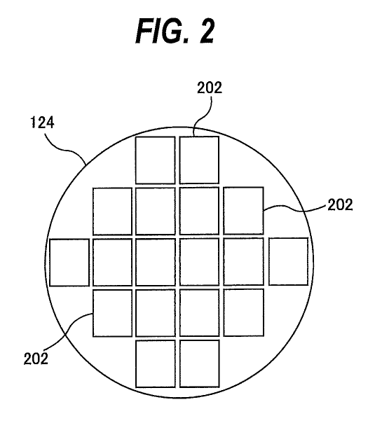

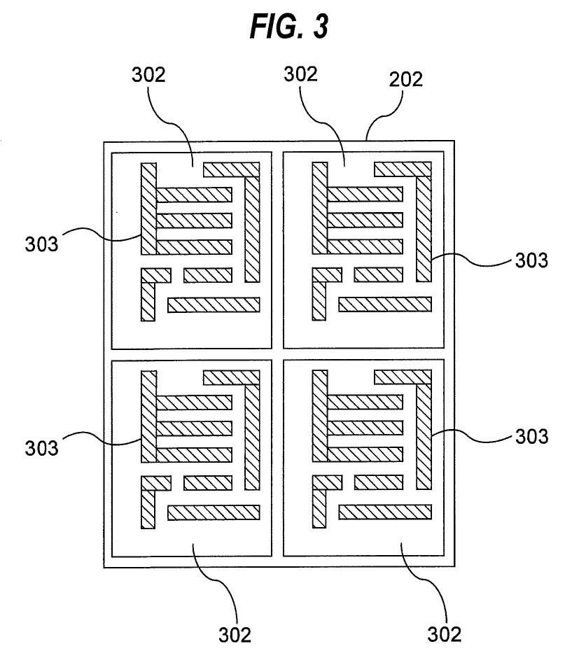

The wafer 124 will be described with reference to FIGS. 2 and 3. A plurality of shots 202 are formed on the wafer 124. Each shot 202 is a unit for drawing photoresist patterns on the wafer 124. The photoresist patterns are used for processing a semiconductor device. As shown in FIG. 3, each shot 202 can include a plurality of chips 302. A pattern 303 is formed in each chip 302. The design data contains two-dimensional design information representing shape and position of the pattern 303 in the chip 302.

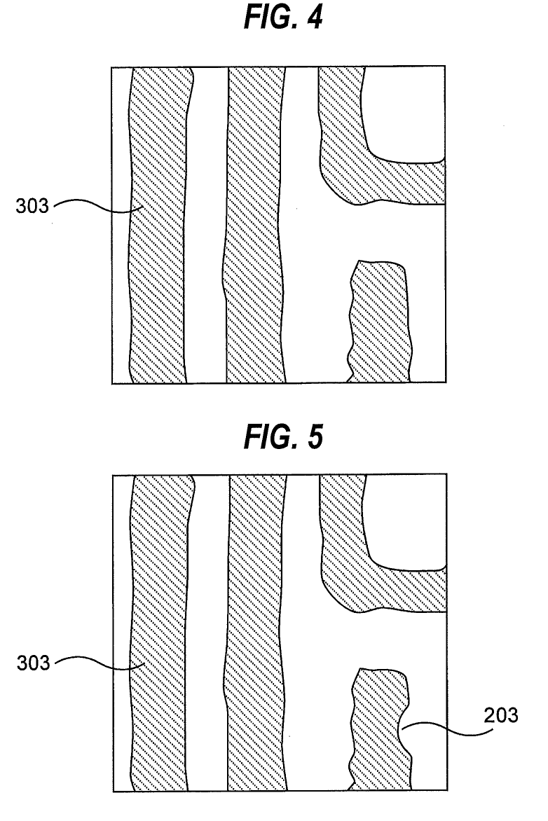

FIG. 4 is a diagram showing a part of the pattern 303 that does not include a defect. LER (line edge roughness) exists in the pattern 303 of FIG. 4, but no defects are present. FIG. 5 is a diagram showing a part of a pattern 303 including a defect. In the pattern 303 of FIG. 5, there are LER (line edge roughness) and a defect 203.

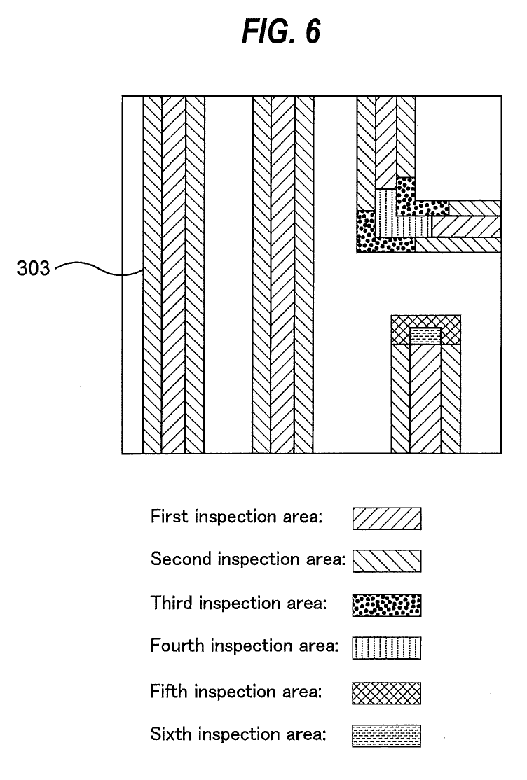

The computer 150 reads the design data from the memory 162, and establishes a plurality of inspection areas based on shapes of pattern edges of the wafer. For example, as shown in FIG. 6, the computer 150 establishes (defines) a plurality of inspection areas on a pattern based on pattern shapes, such as an edge of the pattern, a central portion of the pattern, an end of the pattern, and a corner of the pattern.

In the example shown in FIG. 6, six inspection areas are set on the pattern 303. Specifically, a first inspection area is established at the central portion of the pattern 303, a second inspection area is established at a line edge of the pattern 303, a third inspection area is established at a corner edge of the pattern 303, a fourth inspection area is established at a central portion of a corner of the pattern 303, a fifth inspection area is established at an end edge of the pattern 303, and a sixth inspection area is established at a central portion of an end of the pattern 303.

The scanning electron microscope 100 generates at least one wafer image and the computer 150 obtains the wafer image from the scanning electron microscope 100. A plurality of wafer images may be generated by the scanning electron microscope 100. The wafer image includes a plurality of pattern images. The computer 150 extracts a plurality of pattern images from the wafer image based on the two-dimensional design information included in the design data. These pattern images are images of patterns having the same shape. The number of pattern images to be extracted is preset in the computer 150.

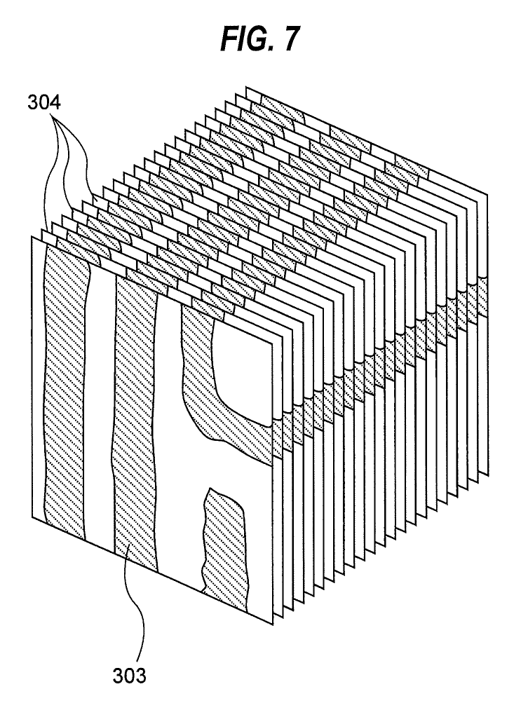

Further, as shown in FIG. 7, the computer 150 superimposes these pattern images 304 while aligning positions of the patterns 303 in the plurality of pattern images 304. For the alignment of the patterns 303, a known technique, such as a normalized cross-correlation method, can be used. The computer 150 calculates a variance of gray level in the plurality of pattern images 304 shown in FIG. 7 for each of the inspection areas shown in FIG. 6. The gray level in each inspection area on each pattern image is an average of the gray levels of pixels constituting that inspection area. For example, the gray level in the first inspection area on a pattern image is the average of the gray levels of the pixels that make up the first inspection area. The gray level is generally a numerical value within the range of 0 to 255.

The pattern images 304 generated by the scanning electron microscope 100 are SEM images expressed in gray scale. When there is no defect in the patterns, there is substantially no variation in the gray scale among the plurality of pattern images 304 at the same position. However, as shown in FIG. 5, when a defect 203 exists in a pattern 303 on a pattern image 304, the variance of the gray level increases because the defect 203 appears white on that pattern image 304.

Thus, in the present embodiment, the computer 150 creates a false-color image by color-coding the plurality of inspection areas according to magnitude of the variance. The computer 150 displays the false-color image on the display device 164. The false-color image is an RGB image, i.e., an image composed of a combination of red, green, and blue. In one embodiment, the computer 150 is configured to apply blue to an inspection area where the variance of the gray level is lower than a first threshold value, apply green to an inspection area where the variance of the gray level falls within a range from the first threshold value to a second threshold value, and apply red to an inspection area where the variance of the gray level is higher than a third threshold value.

In the example shown in FIG. 5, since the defect 203 is present in the first inspection area, the variance of the gray level in the first inspection area becomes large. Therefore, the first inspection area is expressed in red or green.

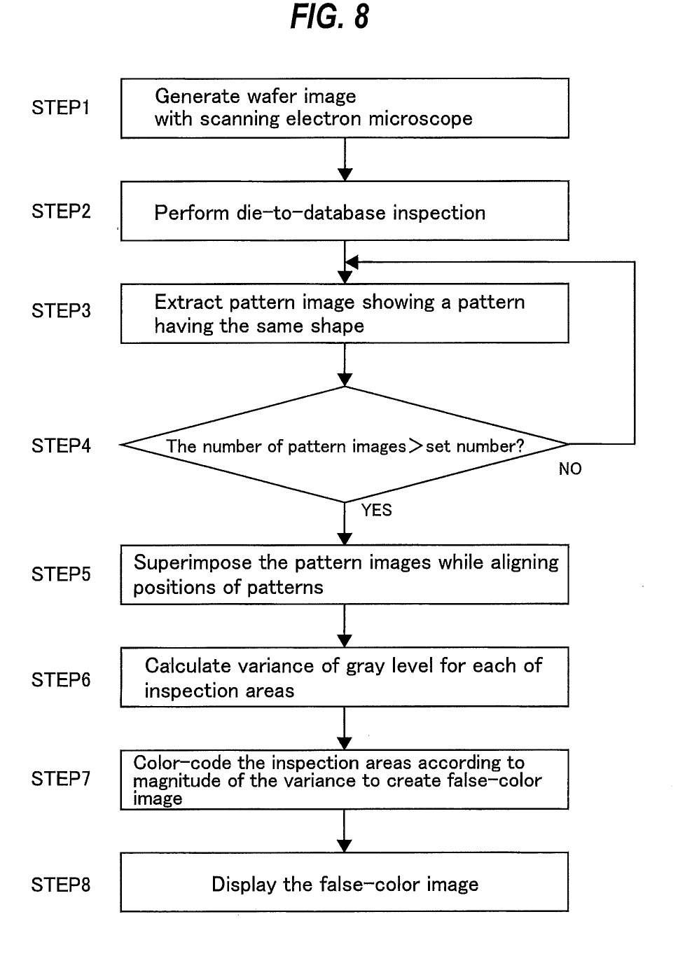

Next, the false color display of the present embodiment will be described with reference to a flowchart shown in FIG. 8. In step 1, at least one wafer image is generated by the scanning electron microscope 100. In step 2, the computer 150 performs a die-to-database inspection to detect pattern edges in the wafer image by comparing a pattern in the wafer image with a pattern in the design data. The die-to-database inspection is described, for example, in U.S. Pat. No. 6,868,175 “Pattern inspection apparatus, pattern inspection method, and recording medium”. The contents of U.S. Pat. No. 6,868,175 are hereby incorporated by reference.

In step 3, the computer 150 extracts an image showing a pattern of the same shape (i.e., a pattern image) from the wafer image. The extraction of a pattern image is repeated until the number of pattern images exceeds a preset number (step 4). In step 5, the computer 150 superimposes a plurality of pattern images while aligning the positions of patterns in the plurality of pattern images (see FIG. 7). For the pattern alignment, a normalized cross-correlation method can be used.

In step 6, the computer 150 calculates the variance of gray level over the plurality of pattern images for each of the plurality of inspection areas on the patterns. The gray level in each inspection area on each pattern image is an average of the gray levels of pixels constituting that inspection area. For example, the gray level in the first inspection area on a pattern image is an average of the gray levels of the pixels that make up the first inspection area. In step 7, the computer 150 creates a false-color image by color-coding the plurality of inspection areas according to the magnitude of the variance. In step 8, the computer 150 displays the false-color image on the display device 164.

According to the present embodiment, the pattern image expressed in gray scale is converted into the false-color image that has been color-coded according to the magnitude of the variance of the gray level. Therefore, a user can easily visually recognize an area where a defect exists.

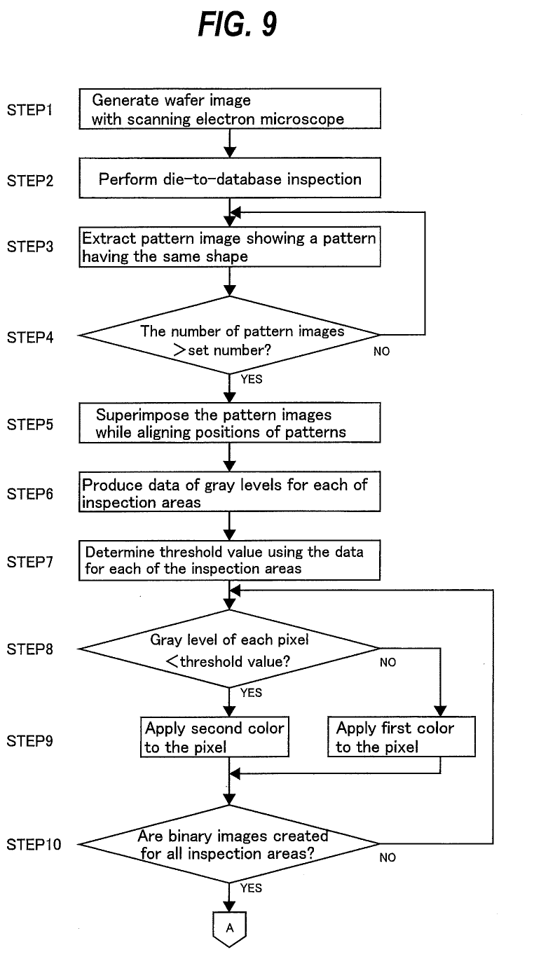

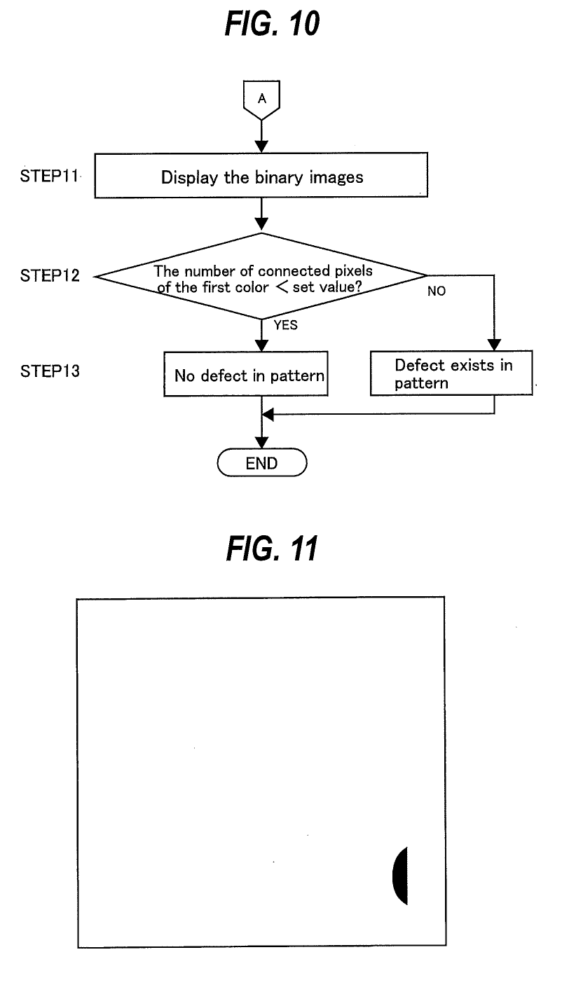

Next, an embodiment for detecting a pattern defect will be described with reference to flowcharts shown in FIGS. 9 and 10. Steps 1 to 5 in FIG. 9 are the same as the steps 1 to 5 in the flowchart shown in FIG. 8, and duplicate descriptions will be omitted.

In step 6, the computer 150 obtains gray levels over a plurality of pattern images for each of a plurality of inspection areas on the patterns, thereby producing data of gray levels (numerical values) for each inspection area. More specifically, the computer 150 obtains gray levels of a plurality of inspection areas of each of the plurality of pattern images, and produces data of gray levels (numerical values) over the plurality of pattern images for each inspection area. The gray level in each inspection area on each pattern image is an average of the gray levels of pixels constituting that inspection area. For example, the gray level in the first inspection area on a pattern image is an average of the gray levels of the pixels that make up the first inspection area.

In step 7, the computer 150 determines a plurality of threshold values corresponding respectively to the plurality of inspection areas, based on the data of gray levels. Each threshold value can be determined based on a quartile range or a standard deviation of the data. For example, the computer 150 calculates a quartile range or a standard deviation of the data in each inspection area, and determines a threshold value by multiplying the quartile range or the standard deviation by a coefficient. The coefficient is a preset numerical value. The coefficient may be 1.

In step 8, the computer 150 compares a gray level of each one of pixels in each inspection area with a corresponding threshold value. For example, the computer 150 compares the gray level of each one of pixels constituting the first inspection area with the threshold value that has been established for the first inspection area. In step 9, the computer 150 applies a first color to pixels having gray levels equal to or higher than the threshold value, and applies a second color to pixels having gray levels lower than the threshold value, thereby generating a binary image. Binary images are generated for all inspection areas (step 10). In step 11, the computer 150 displays the binary images on the display device 164.

As shown in FIG. 10, in step 12, the computer 150 compares the number of connected pixels of the first color with a set number. In step 13, if the number of connected pixels of the first color is equal to or greater than the set number, the computer 150 determines that there is a defect in the pattern. The reason for determining whether or not the number of connected pixels is equal to or more than the set number is to eliminate noise.

FIG. 11 is a diagram showing an example of the binary image. A black region shown in FIG. 11 corresponds to the defect 203 shown in FIG. 5. The user can visually recognize the position of the defect from the binary image.

In the embodiment shown in FIGS. 9 and 10, it is also possible to detect a defect by using, instead of the gray level, a distance from the design data to a pattern outline.

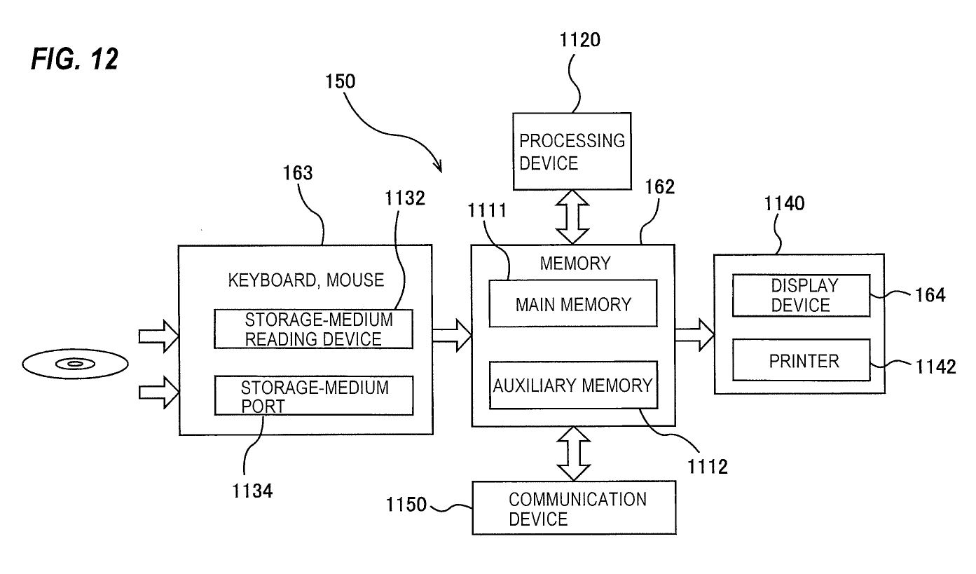

FIG. 12 is a schematic diagram showing the configuration of the computer 150. The computer 150 includes a memory 162 in which a program and data are stored, a processing device 1120, such as CPU (central processing unit), for performing arithmetic operation according to the program stored in the memory 162, an input device 163 for inputting the data, the program, and various information into the memory 162, an output device 1140 for outputting processing results and processed data, and a communication device 1150 for connecting to a network, such as the Internet.

The memory 162 includes a main memory 1111 which is accessible by the processing device 1120, and an auxiliary memory 1112 that stores the data and the program therein. The main memory 1111 may be a random-access memory (RAM), and the auxiliary memory 1112 is a storage device which may be a hard disk drive (HDD) or a solid-state drive (SSD).

The input device 163 includes a keyboard and a mouse, and further includes a storage-medium reading device 1132 for reading the data from a storage medium, and a storage-medium port 1134 to which a storage medium can be connected. The storage medium is a non-transitory tangible computer-readable storage medium. Examples of the storage medium include optical disk (e.g., CD-ROM, DVD-ROM) and semiconductor memory (e.g., USB flash drive, memory card). Examples of the storage-medium reading device 132 include optical disk drive (e.g., CD drive, DVD drive) and card reader. Examples of the storage-medium port 1134 include USB terminal. The program and/or the data stored in the storage medium is introduced into the computer 150 via the input device 163, and is stored in the auxiliary memory 1112 of the memory 162. The output device 1140 includes a display device 164 and a printer 1142.

The computer 150 operates according to the program electrically stored in the memory 162. The program is stored in a non-transitory tangible computer-readable storage medium. The computer 150 is provided with the program via the storage medium. The computer 150 may be provided with the program via communication network, such as the Internet.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A method of visualizing a defect, comprising:
generating pattern images with a scanning electron microscope;
superimposing the pattern images while aligning positions of patterns in the pattern images;
calculating a variance of gray level over the pattern images for each of inspection areas on the patterns;
creating a false-color image by color-coding the inspection areas according to magnitude of the variance; and
displaying the false-color image.

2. The method of visualizing a defect according to claim 1, wherein the inspection areas are established in advance based on shape of the patterns contained in a design data.

3. The method of visualizing a defect according to claim 1, wherein at least one of the inspection areas is an area on an edge of the patterns.

4. A defect detection method comprising:
generating pattern images with a scanning electron microscope;
superimposing the pattern images while aligning positions of patterns in the pattern images;
producing data of gray levels for each of inspection areas on the patterns by obtaining gray levels over the pattern images for each of the inspection areas;
determining threshold values corresponding respectively to the inspection areas, based on the data of gray levels;
comparing a gray level of each one of pixels in the inspection areas with a corresponding threshold value of the threshold values;
applying a first color to pixels having gray levels higher than the threshold value, and applying a second color to pixels having gray levels lower than the threshold value, thereby generating a binary image; and
detecting a pattern defect by detecting connected pixels of the first color whose number is equal to or greater than a set number.

5. The defect detection method according to claim 4, wherein each of the threshold values is determined based on a quartile range or a standard deviation of the data.
